(19) United States
(12) Patent Application Publication
(10) Pub. No.: US 2025/0004145 A1
(43) Pub. Date: Jan. 2, 2025

(54) HIGH-RESOLUTION PHOTON-COUNTING RADIOGRAPHIC IMAGING DETECTOR

(71) Applicant: Stuart Miller, Santa Fe, NM (US)

(72) Inventor: Stuart Miller, Santa Fe, NM (US)

(21) Appl. No.: 18/826,757

(22) Filed: Sep. 6, 2024

Related U.S. Application Data
(63) Continuation of application No. PCT/US23/65835, filed on Apr. 17, 2023.
(60) Provisional application No. 63/333,709, filed on Apr. 22, 2022.

(51) Int. Cl. G01T 1/164; G01T 1/20

(52) U.S. Cl. CPC G01T 1/1642; G01T 1/1648; G01T 1/2018

(57) ABSTRACT

The present invention provides methods and apparatuses for radiographic imaging of ionizing radiation, including X-ray/gamma ray, neutron or other particle imaging, where a scintillator is used to convert high-energy particles or photons to optical photons.

### FIELD OF INVENTION

This invention relates to devices for radiographic imaging, including X-ray/gamma ray, neutron or other particle imaging, where a scintillator is used to convert high-energy particles or photons to optical photons.

### BACKGROUND

Detectors for imaging ionizing radiation traditionally comprise a 2-D scintillator and an optical detector such as a CCD or a CMOS array, in which the scintillator converts the incident radiation (“incident radiation” here can include X-rays, Gamma rays, neutrons, protons, alpha particles or beta particles as examples) into optical photons that are subsequently detected by the optical detector. A wide variety of scintillators are in use for this purpose, with different properties utilized for various specific applications. For imaging purposes, these scintillators are typically 2-D planar films or crystals and there exists a trade-off in the thickness versus the spatial resolution that can be achieved. Specifically, in order to stop a higher proportion of the incident radiation a thicker layer of scintillator is desired, however this results in a reduced spatial resolution due to internal light spread within the scintillator layer itself.

Most of these detectors integrate the optical photons that originate within the scintillator over a period of exposure time to form an image. These integrating detectors form an image by integrating all of the optical light photons that interact with each pixel, which limits the spatial resolution based on the energy and light spread within the scintillator layer. This type of imaging detector is the most common.

Some detectors have been developed that utilize a photon-counting approach in which individual absorbed photons or particles are detected during a relatively short exposure time. Within the scintillator each incident photon or particle that is absorbed produces a burst of optical photons that are emitted in 4π. Each of these “scintillation events” can be seen in the detector as bright spots in the image, and typically these bright spots will be circular or ellipsoidal in nature with a diameter covering a plurality of the detector pixels. Scintillation events can also be streaks depending on the type of radiation. It then becomes possible to perform centroiding of each event to find the center, which corresponds to the location that the original photon or particle was absorbed. With this method, the spatial resolution can be greatly enhanced. Many of these individual images (each consisting of many bright spots) can be processed with the centroiding approach and then summed to form the final image.

The common Anger camera is another example of a photon-counting detector typically used for gammas and neutrons. Here the scintillator can be made relatively thicker so sensitivity is increased. The detector uses Anger logic to roughly approximate the location of the incident events. The resulting spatial resolution is quite poor, typically not better than 0.25-0.5 mm (1-2 line-pairs/mm).

While there are working scintillator-based devices that function for the imaging of X-rays, gamma-rays, and neutrons, all of these detectors heretofore known suffer from a number of disadvantages, including as examples: (a) current detectors suffer from an inherent trade-off between detection efficiency and spatial resolution; (b) current detectors are planar or 2D detectors that offer no measurement of the depth of interaction of the incident radiation; (c) while photon-counting detectors utilizing thin scintillator screens can perform centroiding for enhanced spatial resolution, they still are subject to the trade-off between detection efficiency and spatial resolution; (d) photon counting Anger cameras make it possible to increase efficiency with a thicker scintillator, however the Anger logic used to determine event locations results in poor spatial resolution.

### SUMMARY

Embodiments of the present invention provide a new type of photon-counting detector for high-resolution imaging, comprising a thick transparent scintillator and multiple lens-based cameras that view the individual scintillation events from two or more angles. Embodiments can provide very precise locations of each individual event. Each camera provides a separate view of the scintillator volume, and where these views intersect a 3D volume is delineated within which the scintillation events can very precisely be determined. Each scintillation event is a burst of optical photons in a sphere or oval and the center of each spot can be determined by centroiding to greatly enhance spatial resolution.

Prior to use, a grid consisting of a known array of points can be placed in the volume to calibrate the entire volume of space where the scintillator is then placed.

Embodiments of the invention can provide various advantages, including as examples: (a) providing a scintillator-based photon-counting detector that can very precisely locate each scintillation event within a scintillator volume; (b) providing a radiographic imaging detector that does not suffer from the inherent trade-off between detection efficiency and spatial resolution; (c) providing a radiographic imaging detector that can provide high-resolution of both low-energy and high-energy gamma rays or neutrons; (d) providing a radiographic imaging detector that allows gamma/neutron discrimination; (e) providing a radiographic imaging detector that allows scattered gammas/neutrons to be identified and excluded from the image; (f) providing a radiographic imaging detector that allows the user to select or exclude events based on their depth of interaction within the scintillator volume; (g) providing a radiographic imaging detector that can provide dual energy imaging with one detector; (h) providing a radiographic imaging detector that provides energy resolution for each detected particle based on the total integrated light combined from all cameras.

Embodiments can provide a radiographic imaging detector with an unprecedented combination of detection efficiency and spatial resolution. Embodiments of the invention can impact radiographic imaging of all energy ranges, and can be particularly useful for high-energy particles that are difficult to detect. Embodiments of the invention provide a new type of detector that can have widespread use in a range of applications for imaging ionizing radiation, including as examples X-rays, gamma rays, neutrons (of a wide range of energies), protons, alpha particles, beta particles, muons and possibly others.

### BRIEF DESCRIPTION OF THE DRAWINGS

FIG. 1 shows a top view of an example embodiment of the invention in which two cameras are located to the side of the scintillator.

FIG. 2 shows a top view with a calibration grid.

FIG. 3 shows an isometric view of the scintillator volume with the cameras removed, and also shows a representative single frame 2-D image constructed from the scintillator volume.

FIG. 4 illustrates an example embodiment of the invention with one camera behind and the other orthogonal to the scintillator.

FIG. 5 illustrates an example embodiment of the invention with the cameras focused on the front surface of the scintillator.

FIG. 6 illustrates an example embodiment of the invention in which the cameras are located behind the scintillator.

FIG. 7 illustrates an example embodiment of the invention in which the cameras are located behind a curved scintillator.

FIG. 8 illustrates an example embodiment of the invention in which a collimator is used to image the source of radiation.

### DETAILED DESCRIPTION OF INVENTION

Reference numerals in the drawings correspond to the following elements:

incident radiation 5; camera view 35; object imaged 10; calibration grid or fixture 40; incident radiation after object 15; x dimension of scintillator 45; transparent scintillator volume 20; y dimension of scintillator 50; lens-coupled cameras 25; z dimension of scintillator 55; scintillation events 30; x,y image frame 60; radiation source 65; collimator 70; incident radiation after collimator 75.

Embodiments of the invention comprise a radiographic imaging detector that comprises a thick transparent scintillator and two or more lens-coupled cameras that focus through the volume of the scintillator. Other embodiments comprise relatively thin scintillators or scintillator films.

### Example Embodiment

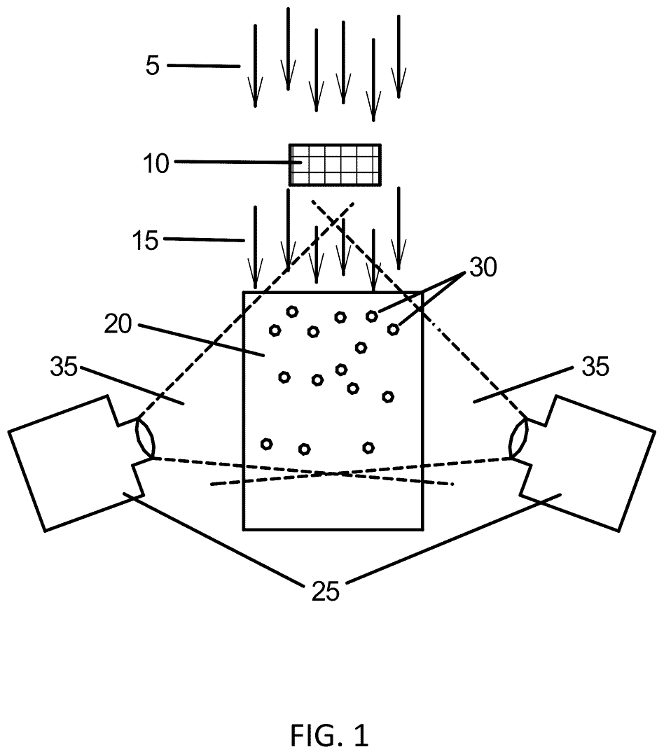

An example embodiment of the present invention is illustrated in a top view in FIG. 1. The incoming incident radiation 5 represents the X-ray, gamma, neutrons or other form of radiation that is used to image an object 10. After passing through the object 10 some of the radiation is absorbed or scattered within the object to form the incident radiation after the object 15 which contains the imaging information of the inside of the object.

The detector comprises a transparent scintillator 20 and two or more lens-coupled cameras 25. FIG. 1 shows two cameras which represent the minimum number of cameras for this detector. However three or more cameras 25 can be used, and this can further increase the precision, accuracy, or both, with which the scintillation events 30 are located. As the incident radiation after the object 15 enters the scintillator, some of the radiation is absorbed to form scintillation events 30 within the scintillator volume. When those scintillation events 30 occur within the volume 20 delineated by the cross-section of both camera views 35, they can be resolved by both cameras 25. Because they are viewed by both cameras 25 the location of each event 30 can be determined within the 3-dimensional space with great precision. This precision can be even further enhanced by centroiding or COM (center of mass) calculation of a larger spot size to find the center point of a circle or oval representing each event 30.

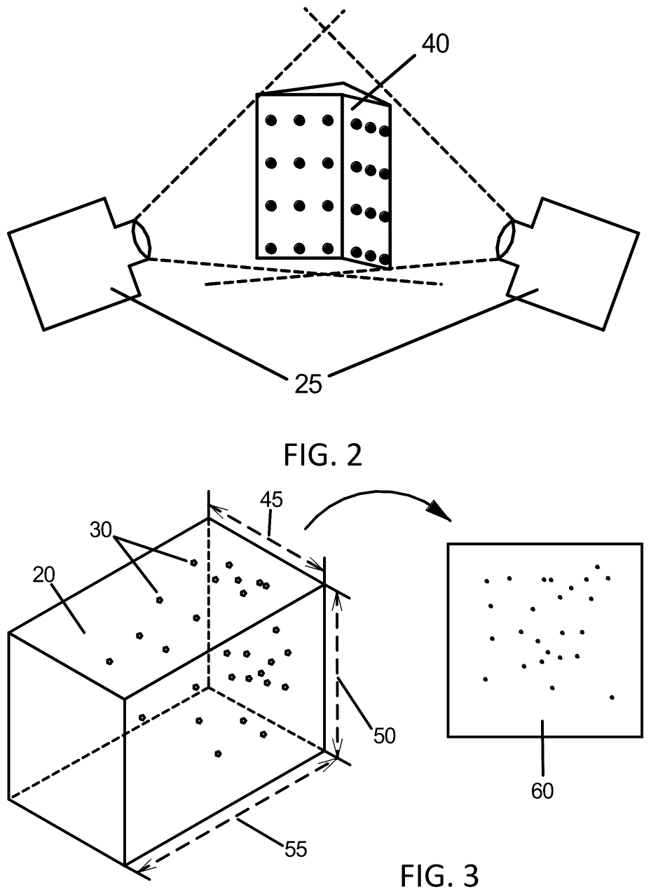

FIG. 2 shows the cameras 25 with a calibration grid 40 in place. Prior to use with the scintillator 20, the volume delineated by the cross-section of the camera views 35 can be calibrated. This can be done with a grid with known points that allows the entire 3D volume to be calibrated. Calibration fixtures typically comprise an array of equally spaced points in two planes at a known angle. After calibration any point that is viewed by both cameras 25, can now be determined with x,y,z coordinates within the volume.

FIG. 3 shows an isometric view of the scintillator volume 20 with the cameras removed for clarity. The dimensions of the scintillator volume 20 are indicated as the x-dimension 45, y-dimension 50, and z-dimension 55 (or depth). This represents a single frame of imaging with the imaging frames synchronized from both cameras 25. The image is then formed in the x,y frame 60 by flattening the z-dimension 55 to show the events in 2 dimensions. Here the events can be separated by their z-dimension 55 if desired.

The cameras or other imaging devices can be controlled as is known to those skilled in the art. The locations and calibrations can be determined using a determination system, which can comprise, as examples, a programmed computer, a special purpose computer, digital or analog circuitry, applications on general purpose computing devices such as personal computers, tablets, or smart phones, or other systems known to those skilled in the art. The determination system can be mounted close to the detector system, or at a distance with data communicated using wired or wireless communication. The determination can be done near the time of acquiring the images or signals, or after time has elapsed in a post-processing system, or a combination thereof.

### Example Embodiments

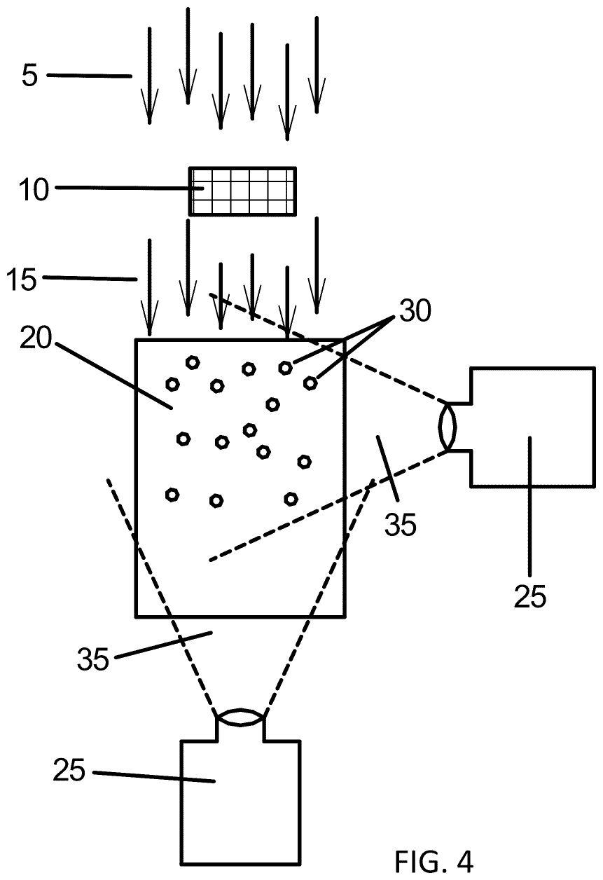

An example embodiment is shown in FIG. 4. Here the cameras 25 are shown with one behind the scintillator and one orthogonal to the scintillator 20. The cameras 25 can be placed in any orientation with the scintillator 20 in view of both cameras 25. The detection volume for the scintillation events 30 will be determined by the space within the scintillator 20 in the views 35 of both cameras 25.

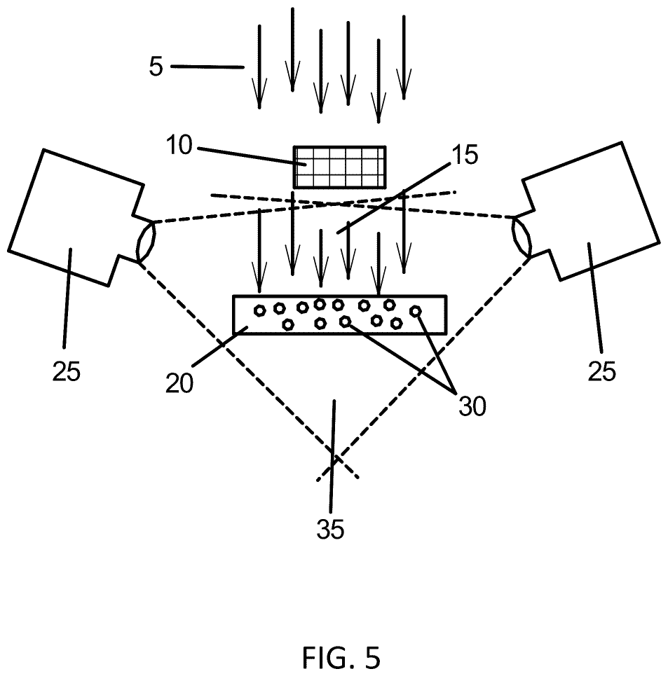

FIG. 5 shows an example embodiment in which the cameras 25 are placed in front of a scintillator 20. In this embodiment the scintillator is shown to be thinner, and the need for transparency is relaxed. Because there are two or more cameras 25 used, the location of the scintillation events 30 can be determined with great precision.

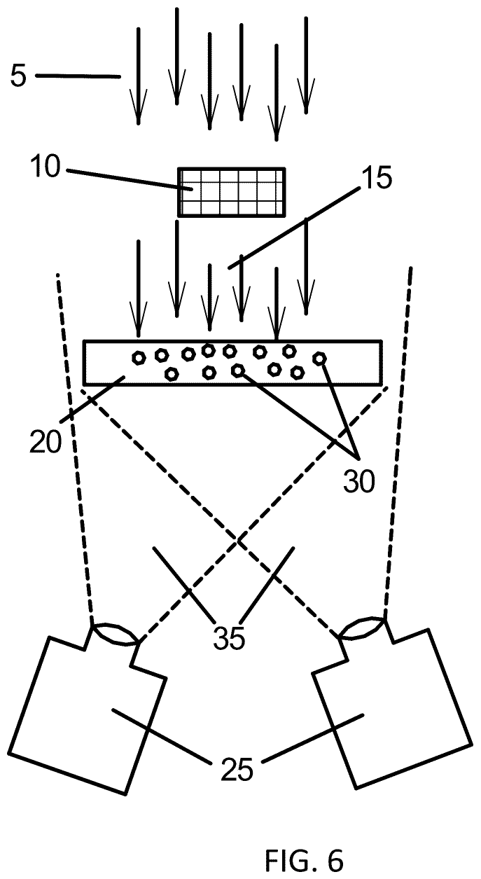

FIG. 6 shows an example embodiment in which the cameras 25 are placed behind a thinner scintillator 20.

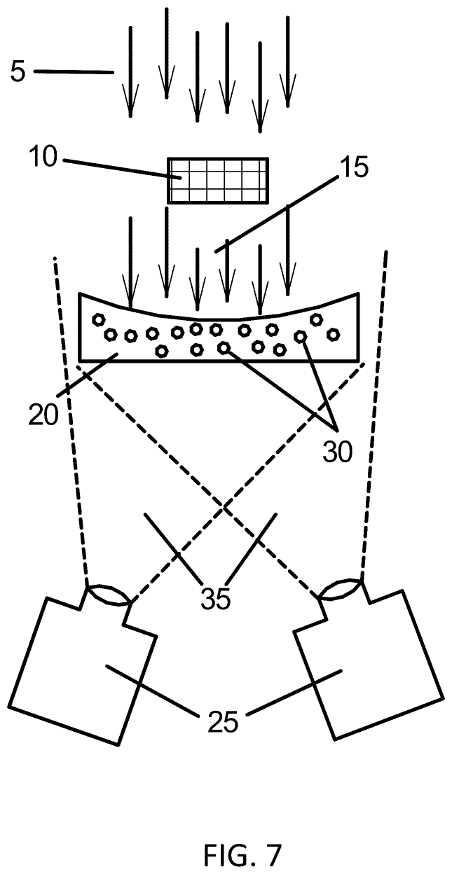

FIG. 7 shows an example embodiment in which the scintillator 20 is curved. This reduces or eliminates parallax error.

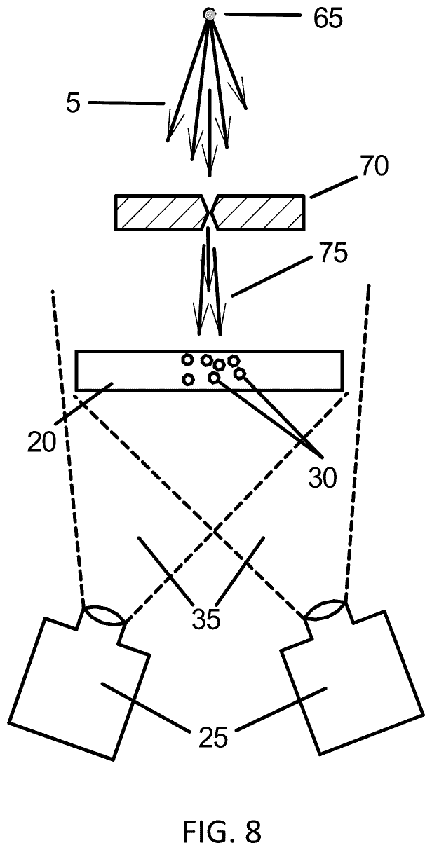

FIG. 8 shows an example embodiment where this imaging system can be used in conjunction with a pinhole, multi-hole, or a coded aperture collimator 70. This can be used to image the source of the radiation 65 itself; for example to image the spot size of an X-ray source or to image radioactive isotopes in applications such as SPECT.

Other example embodiments can include more cameras (not shown). For example, three cameras 25 placed 60° apart can provide three views of each scintillation event 30. This provides increased precision in locating the exact position of each event 30.

Another example embodiment (not shown) includes mirrors placed in between the camera or cameras 25 and the scintillator 20. The views 35 can thus easily be adjusted to achieve the desired imaging volume. In addition, in this embodiment it is possible to use mirrors to focus two or more views on a single sensor array.

### Example Operation

This photon-counting detector works with the cameras 25 operating in continuous framing mode, with the cameras' 25 acquisition times synchronized so that the cameras 25 acquire image frames at the exact same time. It can be important that they are synchronized so that they are looking at the scintillation events 30 simultaneously from two or more views 35, depending on how many cameras are employed. Prior to imaging an unknown object, a calibration grid 40 or something else with points that have known positions can be placed within the volume and imaged there in order to calibrate the volume where the scintillator 20 will subsequently be placed. Once the calibration is complete, anything viewed within that volume can be located in 3-dimensional space with x, y, z coordinates, with the cameras remaining stationary.

A transparent scintillator 20 can then be placed in the calibrated volume, inside a light-tight box. The camera frame rates can be set at a speed such that the desired number of scintillation events 30 are visible within the volume in each frame. If there are too many events 30 in each frame it can become difficult to resolve individual events 30 that occur close to each other. Also, events 30 farther away from the cameras 25 can be obscured by events in the foreground. The frame rate can be chosen specifically for each application depending on the flux of incident radiation 5. For example, the desired number of events 30 can be in the range from 1-100 or more.

In each frame, there can be some number of events 30 within the scintillator 20 volume that are viewed 35 by both cameras 25, or multiple cameras. These events 30 will have known locations in terms of x, y, z coordinates. Each event 30 can be centroided to find its precise location, which can enhance spatial resolution. The z coordinate 55 can be used to select the events 30 that are desired to form the image. For example, it is possible to exclude the events 30 closer to the front face of the scintillator 20, if desired. These would normally be associated with lower-energy incident radiation 5, 15, since they do not penetrate as far into the scintillator volume. Or conversely, one can make separate images with the front events making one image and the events near the rear in another image. With the desired z range defined, the x, y coordinates can then be used to form an x, y image frame 60 for each frame.

The scintillation events 30 can also be integrated in order to quantify the total light emitted from each event 30. This can provide another way to filter or select the desired events 30 to be used to form the image.

Forming an image of an object 10 can require many such frames 60 to be acquired. This can require a plethora of images 60 and thousands to millions of events 30 to form the final image (for example). In general, the more events 30 that make up the image, the better the object 10 will be resolved. To form a final image, the pixels in the x, y frame 60 where an event 30 was registered can be given an arbitrary value (e.g., 100) and then the complete set of image frames 60 can be summed. With the x, y, z coordinate data now determined in each frame, algorithms can be used to compile this information into 2D images of the object 10. These resulting images can provide unprecedented spatial resolution of the object 10.

### Other Considerations

Embodiments of this invention provide an apparatus that can detect X-rays, gammas, neutrons or other radiation with great precision within the scintillator. This results in an image with greatly enhanced spatial resolution. Because it is a photon-counting detector, it can be more amenable to applications where the incoming flux is not too high relative to the shortest exposure time of the detector. It is simply a matter of getting the desired number of events within each frame. Although with high-speed cameras or other 2D detectors such as SiPM arrays (silicon photo-multiplier arrays) it is feasible to also use this detector in applications with higher flux. Also, with more cameras, e.g., 3, 4, or more, this will also make it more amenable to applications where higher flux is observed.

Although the description above contains many specificities, these should not be construed as limiting the scope of the invention but as merely providing illustrations of some of the presently preferred embodiments of this invention. Many other variations are possible. For example, as mentioned above, more cameras can be utilized. The examples in the figures depict an embodiment with two cameras. Having more cameras can provide greater precision in locating the coordinates of each event.

Thus the scope of the invention should be determined by the appended claims and their legal equivalents, rather than by the examples given.

What is claimed is:

1. A detector apparatus, comprising:
(a) a scintillator, configured to produce optical light photons in response to incident radiation, where the scintillator creates a plurality of optical light photons at a location within the scintillator in a photon creation event responsive to a discrete incident radiation event;
(b) a plurality of sensors, each configured to produce a signal corresponding to the location in two dimensions of a photon incident on the sensor from a field of view of the sensor;
(c) wherein each sensor is mounted with the scintillator such that a three dimensional volume of the scintillator is in the field of view of each of the sensors, and such that the fields of view of at least two sensors are at different angles into the three dimensional volume;
(d) a determination system configured to determine the location within the three dimensional volume of the scintillator where a photon was produced from the signals from the plurality of sensors.

2. The detector apparatus of claim 1, wherein the plurality of sensors comprises a plurality of planar image capture devices each having a field of view of a portion of the scintillator, where the fields of view overlap, and where at least two of the fields of view are distinct from each other.

3. The detector apparatus of claim 2, wherein the planes of two sensors are not parallel.

4. The detector apparatus of claim 1, further comprising a sampling control system configured to capture signals from each of the plurality of sensors at a sample time that is substantially the same for each of the plurality of sensors.

5. The detector apparatus of claim 4, wherein the sampling control system is configured to capture signals from each of the plurality of sensors at a plurality of sample times.

6. The detector apparatus of claim 1, wherein the determination system is configured to determine the centroid of a photon creation event expressed in the signals.

7. The detector apparatus of claim 1, wherein the determination system is configured to determine a direction of incident radiation from an elongated axis of a photon creation event expressed in the signals.

8. The detector apparatus of claim 1, wherein the determination system is configured to distinguish photon creation events of incident gamma radiation from photon creation of incident neutrons responsive to intensity, shape, or a combination of photon creation events expressed in the signals.

9. The detector apparatus of claim 1, wherein the determination system is configured to integrate the signals over time to determine a measure of energy incident on the scintillator.

10. The detector apparatus of claim 1, wherein the determination system is configured to store locations of photon creation events over a period of time.

11. The detector apparatus of claim 1, wherein the determination system is configured to form a high resolution radiographic image from the signals.

12. The detector apparatus of claim 11, wherein the determination system is configured to filter the radiographic image based on the depth in the scintillator of the photon creation event as determined from the signals.

13. The detector apparatus of claim 1, wherein the sensors comprise one or more of CCD's, EMCCD's, image-intensified CCD's, CMOS, or SiPM detectors.

14. The detector apparatus of claim 1, further comprising a collimator mounted between the scintillator and a source of radiation.

15. The detector apparatus of claim 1, wherein the scintillator is a transparent or translucent crystalline or ceramic scintillator.

16. The detector apparatus of claim 1, wherein the scintillator is a curved scintillator.

17. The detector apparatus of claim 1, wherein the determination system is configured to sort photon creation events according to type of incident radiation.

18. A method of determining locations in three dimensions of photon creation events responsive to radiation incident on a scintillator, comprising:
(a) providing a plurality of imaging devices, each mounted with the scintillator such that the fields of view of the imaging devices overlap within the scintillator;
(b) capturing an image from each of the imaging devices of a portion of the scintillator that is within the field of view of each of the imaging devices;
(c) determining the location in two dimensions, defined by the imaging device, of a photon creation event in the scintillator, for each of the images;
(d) determining the location in three dimensions, defined by the scintillator, of the photon creation event from the locations in two dimensions determined in step (c) and from the geometric relationships of the imaging devices and the scintillator.

19. A method as in claim 18, wherein step (c) comprises determining a centroid of the photon creation event in the two dimensions, and wherein step (d) comprises determining a centroid of the photon creation event in three dimensions.

20. A method as in claim 18, further comprising determining a calibration of the imaging devices using a calibration device providing signals at known locations, which locations are within the fields of the view of the imaging devices.
